(19) United States
(12) Patent Application Publication
(10) Pub. No.: US 2012/0011103 A1
(43) Pub. Date: Jan. 12, 2012

(54) SYSTEM AND METHOD FOR PROVIDING SEARCH SERVICE

(75) Inventors: Hwan Soo JOO, Seoul (KR); Bo Ra KIM, Daejeon (KR)

(73) Assignee: NHN CORPORATION, Seongnam-si (KR)

(21) Appl. No.: 13/179,149

(22) Filed: Jul. 8, 2011

(30) Foreign Application Priority Data
Jul. 9, 2010 (KR) 10-2010-0066435

(51) Int. Cl. G06F 17/30

(52) U.S. Cl. 707/687; 707/769; 707/722; 707/E17.014; 707/E17.005

(57) ABSTRACT

Provided are a system and a method for providing a search service. The system and the method for providing the search service select a search attribute with respect to documents to be searched for based on a request from a user and provide a search service based on the selected search attribute.

### BACKGROUND OF THE INVENTION

1. Field of the Invention

Exemplary embodiments of the present invention relate to a system and a method for providing a search service, and more particularly, to a system and a method for providing a search service which provides a limited search service according to attributes of a user who posts a document via a microblog service or social network service.

2. Discussion of the Background

Generally, a microblog service is a type of a blog service, which enables the exchange of news using short sentences, and is updated in real time. A representative example of the microblog service is Twitter. A microblog service is a blog that enables communications with other people using short messages having one or two sentences, and is also referred to as a miniblog. A microblog is a form of a social network service (SNS), which helps to promote relationships with acquaintances and to build new relationships among people on the Internet. Twitter, which is a top example of microblogs, was created in 2006 by a venture company, Obvious Corporation in San Francisco, has friend finding and messaging functions, and allows users to send and read posts of up to 140 characters. In addition to Twitter, widely used microblogs include international sites, such as Fanfou, iLaodao, and the like, and Korean sites, such as Me2 day, Yozm, and the like. Microblogs can be accessed through mobile phones without connecting to the Internet through a computer. In particular, as interest in mobile Internet access increases with the introduction of smart phones, microblogs are becoming increasingly popular.

Generally, an SNS is a service enabling users to build human networks on the Internet, and widely used SNSs are, for example, Twitter, Cyworld, Facebook, and the like. Social network services enable promotion of personal connections with acquaintances, such as friends, seniors, juniors, and colleagues, creation of new social relationships, and building of human networks (relationships). Further, a social network service is also referred to as a one-man media or one-man community which helps to share personal information and aids in communication.

However, a conventional microblog or SNS enables communication with other people using short messages having one or two sentences, but does not provide a search function for registered messages. Thus, it is not easy to search for information desired by a user.

### SUMMARY OF THE INVENTION

Exemplary embodiments of the present invention provide a system and a method for providing a search service which provides a limited search service according to attributes of a user who posts a document via a microblog service or social network service.

Exemplary embodiments of the present invention also provide a method and a system for providing a search service which selects a search attribute with respect to documents to be searched for based on a request of a user and provide a search service based on the selected search attribute in a microblog service or social network service.

Further, exemplary embodiments of the present invention also provide a method and a system for providing a search service which search for a particular subject with respect to a post about a particular category, such as books, movies, music, television (TV) programs/dramas, and famous restaurants in a microblog service or social network service.

Moreover, exemplary embodiments of the present invention also provide a method and a system for providing a search service which searches for posts within the limitations of a particular region/scope based on a posting location of a post in a microblog service or social network service.

In addition, exemplary embodiments of the present invention also provide a method and a system for providing a search service which provides information about a number of postings by periods, and provides a graphic timeline based on posting date of posts searched-for in a microblog service or social network service so that a user easily recognizes a period during which posts with respect to a keyword are posted most often.

An exemplary embodiment of the present invention discloses a system of providing a search service, wherein the system includes a selection unit for selecting a search attribute with respect to documents to be searched for based on a request from a user and a search service provider providing a search service based on the selected search attribute.

The selection unit may select a user who has a friendship with the user or a particular user designated by the user as the search attribute, and may provide a search result with respect to the user selected as the search attribute.

The selection unit may select a limited category as a search attribute with respect to registered documents, and the search service provider may provide a search result with respect to the selected category among the registered documents.

The limited category may be a category in which the documents are registered by the user to be searched for by other users or a category corresponding to a subject of the registered documents.

The selection unit may select a posting location, indicative of a location from which the registered documents are registered by the user, to be set by the user or to be automatically registered, and the search service provider may search for a document posted within a region or scope according to the posting location and may provide a search result for the document.

The search service provider may provide a search result with respect to the selected object to be searched for based on a posting time of a found document.

The search service provider may provide a graphic time line generated based on the posting time of the found document.

The selection unit may select, as the search attribute, one of a private section for administration of private postings with respect to the documents to be searched for, a community section for communication with limited groups, and a common section for communication with all users.

The system may further include an administration unit to provide a warning about the object to be searched for or to delete the object to be searched for when receiving a warning about the object to be searched for from a user identifying the search results or receiving a deletion request with respect to the search service from a monitor.

The selection unit may select the status of a poster or a posting status with respect to a document to be searched for based on the request of the user, and the search service provider may provide a search result of a document to be searched for satisfying search target conditions with respect to the selected status of the poster or the selected posting status.

Another exemplary embodiment of the present invention discloses a method of providing a search service, wherein the method includes selecting a search attribute with respect to documents to be searched for based on a request from a user and providing a search service based on the selected search attribute.

The selecting of the search attribute may include selecting a user who has a friendship with the user or a particular user designated by the user as the search attribute, and the providing of the search service may provide a search result with respect to the user selected as the search attribute.

The selecting of the search attribute may include selecting a limited category as a search attribute with respect to registered documents, and the providing of the search service may provide a search result with respect to the selected category among the registered documents.

The limited category may be a category in which the documents are registered by the user to be desirably searched for by other users or a category corresponding to a subject of the registered documents.

The selecting of the search attribute may include selecting a posting location in which the registered documents are registered by the user, to be set by the user or to be automatically registered, and the providing of the search service may search for a document posted within a region or scope according to the posting location and may provide a search result for the document.

The providing of the search service may provide a search result with respect to the selected object to be searched for based on a posting time of the found document.

The providing of the search service may provide a graphic timeline generated based on the posting time of the found document.

The selecting of the search attribute may include selecting, as the search attribute, one of a private section for administration of private postings with respect to the documents to be searched for, a community section for communication with limited groups, and a common section for communication with all users.

The method may further include managing to provide a warning about the object to be searched for or to delete the object to be searched for when receiving a warning about the object to be searched for, from a user identifying the search results or receiving a deletion request with respect to the search service displayed on a monitor.

The selecting of the search attribute may include selecting the status of a user or a posting status with respect to a document to be searched for based on the request of the user, and the providing of the search service may provide a search result of a document satisfying search target conditions with respect to the selected status of the poster or the selected posting status.

### EFFECT OF THE INVENTION

According to embodiments of the present invention, there is provided a system and a method for providing a search service which provides a limited search service according to attributes of a user who composes a document in a microblog service or social network service.

According to embodiments of the present invention, there is also provided a method and a system for providing a search service which selects a search attribute with respect to documents to be searched for based on a request of a user and provides a search service based on the selected search attribute in a microblog service or social network service.

Further, according to embodiments of the present invention, there is also provided a method and a system for providing a search service which search for a particular subject with respect to a post about a particular category, such as books, movies, music, television (TV) programs/dramas, and famous restaurants in a microblog service or social network service.

Moreover, according to embodiments of the present invention, there is also provided a method and a system for providing a search service which search for posts within the limitations of a particular region/scope based on the posting location of a post in a microblog service or social network service.

In addition, according to embodiments of the present invention, there is also provided a method and a system for providing a search service which provides information about a number of postings by periods and provides a graphic timeline based on posting date of posts searched-for in a microblog service or social network service so that a user easily recognizes a period during which posts with respect to a keyword are posted the most.

### BRIEF DESCRIPTION OF THE DRAWINGS

FIG. 1 illustrates a connection between a search service system and user terminal according to an exemplary embodiment of the present invention.

FIG. 2 illustrates a configuration of a search service system according to an exemplary embodiment of the present invention.

FIG. 3 illustrates a blog search service and a social network service according to an exemplary embodiment of the present invention.

FIG. 4 illustrates a screen to select the scope of a search in a search service according to an exemplary embodiment of the present invention.

FIG. 5 illustrates a screen showing a result of a search service according to an exemplary embodiment of the present invention.

FIG. 6 illustrates a screen showing a result of a search service with respect to all posts in a search service according to an exemplary embodiment of the present invention.

FIG. 7 illustrates an arrangement option in a search service according to an exemplary embodiment of the present invention.

FIGS. 8A and 8B illustrate search result pages with respect to a particular subject in a search service according to an exemplary embodiment of the present invention.

FIG. 9 illustrates an operational process of a search service method according to an exemplary embodiment of the present invention.

### DETAILED DESCRIPTION OF THE ILLUSTRATED EMBODIMENTS

Hereinafter, a search service system and method according to exemplary embodiments of the present invention will be described with reference to the accompanying drawings.

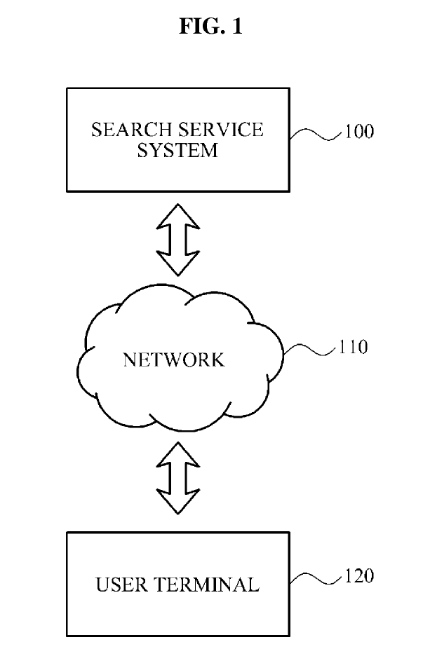

FIG. 1 illustrates a connection between a search service system and user terminal according to an exemplary embodiment of the present invention.

Referring to FIG. 1, the search service system 100 receives selection of a search scope in a microblog service or social network service from the user terminal 120 connected through a network 110. The search scope denotes search attributes that a user desires to search for in a service and may include attributes of a user of postings, limited categories of postings, or locations of postings. Here, the postings are texts posted by a user who uses a microblog service or a social network service.

The search service system 100 searches documents in the microblog service or social network service based on the selected search scope.

The search service system 100 transmits a result of searching for a document based on the selected search scope to the user terminal 120 connected through the network 110.

The network 110 transmits and receives various types of data between the search service system 100 and the user terminal 120 through a wire-based or wireless communication network.

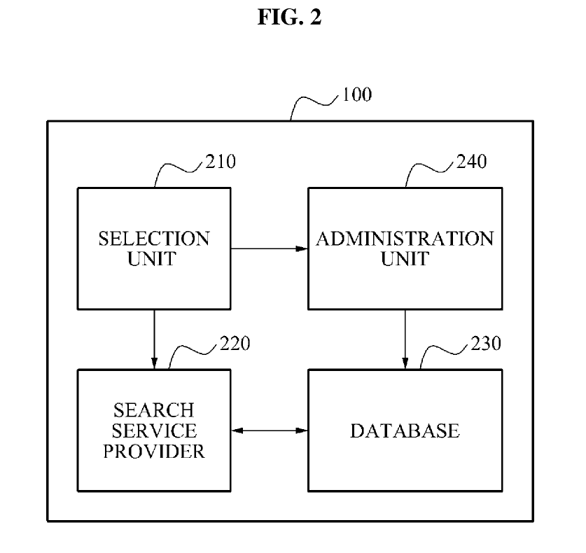

FIG. 2 illustrates a configuration of a search service system according to an exemplary embodiment of the present invention.

Referring to FIGS. 1 and 2, the search service system 100 according to the exemplary embodiment includes a selection unit 210, a search service provider 220, a database 230, and an administration unit 240.

The selection unit 210 selects a search attribute with respect to documents to be searched for based on a request from a user. That is, the selection unit 210 selects the search attribute of the documents to be searched for based on the request received from the user terminal 120 connected through the network 110. The search attribute may include attributes of the poster of a document, a limited category of the document, or the location where the document was composed. For example, the document may be a posting written by a user of a microblog or a social network service. In one embodiment, the selection unit 210 may select a user who has a friendship with the user or a particular user chosen by the user as the search attribute. For example, in order for the user to search for a document composed personally by the user, the selection unit 210 may select the user himself or herself as the search attribute.

Alternatively, the selection unit 210 may select a limited category as a search attribute with respect to registered documents. The limited category is a category in which the documents are registered by the user who desires the documents to be searched for the category by other users or a category corresponding to the subject of the registered documents. For example, the selection unit 210 may select a limited category, such as books, movies, music, TV programs/dramas, or famous restaurants, with respect to postings posted in a microblog service or a social network service.

Furthermore, the selection unit 210 may select a posting location, indicative of a location where the registered documents are registered by the user, to be set by the user or to be automatically registered. The user is allowed to personally register the posting location in wired/wireless environments through the user terminal 120. When the user terminal 120 has a location recognition function, the user terminal 120 automatically registers the posting location of the documents.

Alternatively, the selection unit 210 may select, as the search attribute, one of a private section for managing of private postings with respect to the searched-for documents, a community section for communication with limited groups, and a common section for communication with all users.

Alternatively, the selection unit 210 may select the status of poster or the posting status with respect to a document to be searched for based on the request from the user, received from the user terminal 120 through the network 110.

The search service provider 220 provides a search service based on the selected search attribute. That is, the search service provider 220 provides a search result to the user of the user terminal 120 who selects the search attribute through the network 110 based on a search attribute selected through the selection unit 210.

In one embodiment, the search service provider 220 may provide a search result with respect to a particular user, selected by the user, to the user of the user terminal 120 who selects the search attribute through the network 110. For example, when the user selects a search attribute to search for a document posted by the user himself/herself in a microblog service or social network service, the search service provider 220 may provide a search result of searching for the selected document posted by the user himself/herself, to the user of the user terminal 120 who selects the search attribute through the network 110.

As an example, the search service provider 220 may provide a search result with respect to the selected category among the registered documents to the user of the user terminal 120 who selects the search attribute through the network 110. For example, when a category such as famous restaurant is selected through the selection unit 210, the search service provider 220 may provide a search result corresponding to a famous restaurant among entries posted in a microblog service or a social network service to the user of the user terminal 120 who selects the search attribute through the network 110.

Also, as another example, the search service provider 220 may search for a document corresponding to a region or scope based on the posting location of the document in the microblog service or the social network service and may provide a search result for the document to the user of the user terminal 120 who selects the search attribute through the network 110.

Moreover, as yet another example, the search service provider 220 may provide a search result with respect to the selected search objects based on the posting times of found documents. For example, the search service provider 220 may provide a timeline graph generated based on the posting times of the found documents.

Alternatively, the search service provider 220 provides a searched document satisfying search target conditions with respect to the selected status of the poster or the posting status to the user of the user terminal 120 who selects the search attribute through the network 110.

The database 230 records and maintains documents composed by users, search attributes selected by the users, and search result data based on the selected search attributes.

The search service provider 220 searches for documents recorded in the database 230 based on the search attributes selected by the users and provides search results to the user of the user terminal 120 who selects the search attributes through the network 110.

The administration unit 240 provides a warning about an object to be searched for or deletes the object to be searched for when receiving a warning about the object to be searched for from a user identifying the search results or receiving a deletion request with respect to the search service from a monitor.

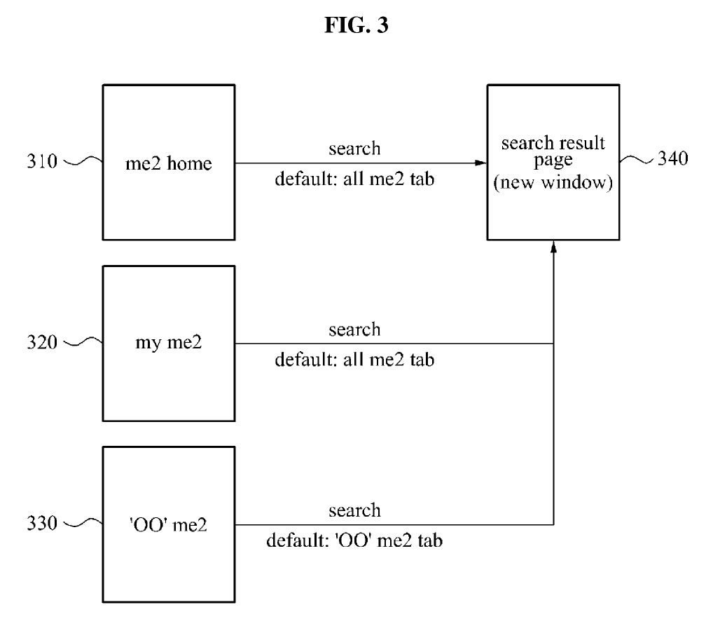

FIG. 3 illustrates a blog search service and a social network service according to an exemplary embodiment of the present invention.

Referring to FIG. 3, a Me2 service is a representative blog search service or social network service. For instance, when a user requests a search service in a me2 home 310 and a my me2 320, since an all me2 tab is a default, search results in an all me2 are provided in a search result page 340 displayed in a new window. When the user requests a search service in an ‘OO’ me2 tab 330, since the ‘OO’ me2 tab is a default, search results in the ‘OO’ me2 are provided on the search result page 340 displayed in a new window, unless the user sets up a particular search attribute.

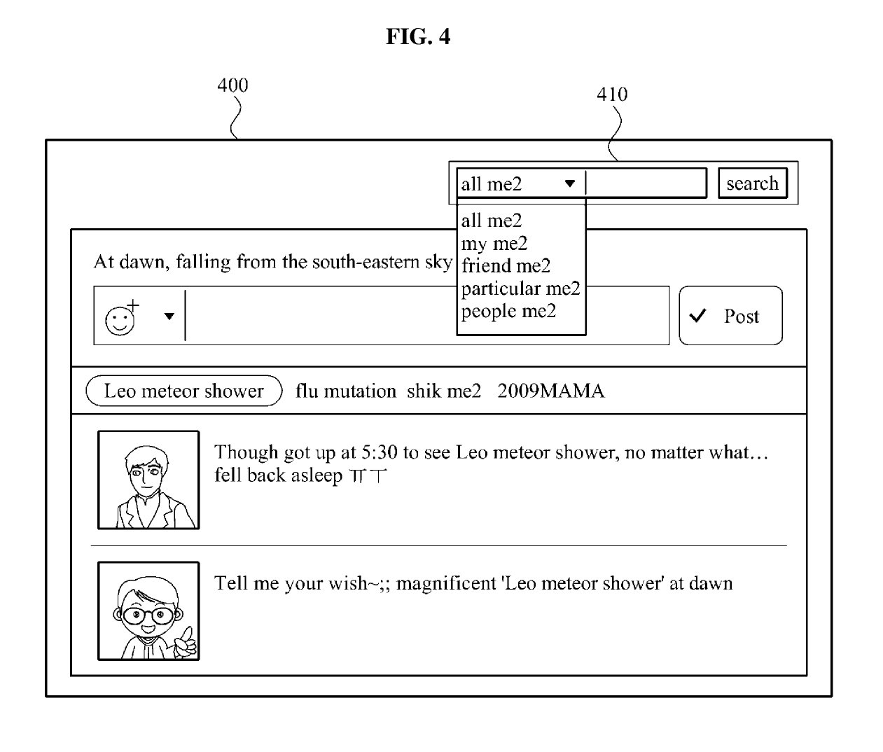

FIG. 4 illustrates a screen to select a scope of a search through in a search service according to an exemplary embodiment of the present invention.

Referring to FIG. 4, a search service screen 400 includes a search window section 410. Using the search window section 410, a user selects the scope of an object to be searched for in a microblog service or social network service, and inputs a keyword to be searched for. For example, the search window section 410 displays a pull-down search window option menu with a click of a mouse, and displays search options, such as all me2, my me2, friend me2, particular me2, people me2, and the like.

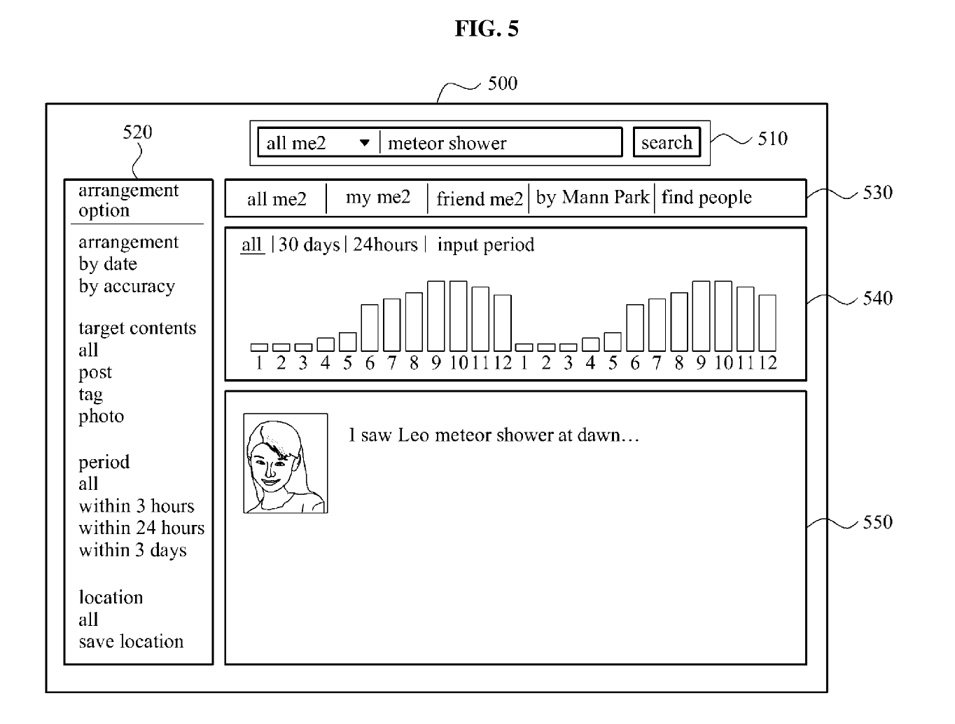

FIG. 5 illustrates a screen showing a result of a search service according to an exemplary embodiment of the present invention.

Referring to FIG. 5, a search service result screen 500 includes a search window section 510, an arrangement option section 520, a search tab section 530, a timeline section 540, and a search result section 550. The search window section 510 is a section for input of search window options and keywords, in which search options may be selected by the user. The arrangement option section 520 is a section for refining search results, in which arrangement options are always displayed in pull-down search window option menus, and selected items may be AND-searched for. The search tab section 530 displays search results in divided tabs and changes a search window option along with a search tab selected. For example, when a ‘my me2’ tab is selected, the search window option is changed to ‘my me2.’ Further, the search tab is section 530 displays all me2, my me2, friend me2, by a particular user, and find people tabs in the login status, whereas the search tab section 530 displays all me2, by a particular user, and find people tabs in the logout status.

The timeline section 540 displays a chronological graph of search results, provides a chronological navigation function, and is connected with a period item in the arrangement options, and the search result section 550 displays search results based on a search attribute selected by the user.

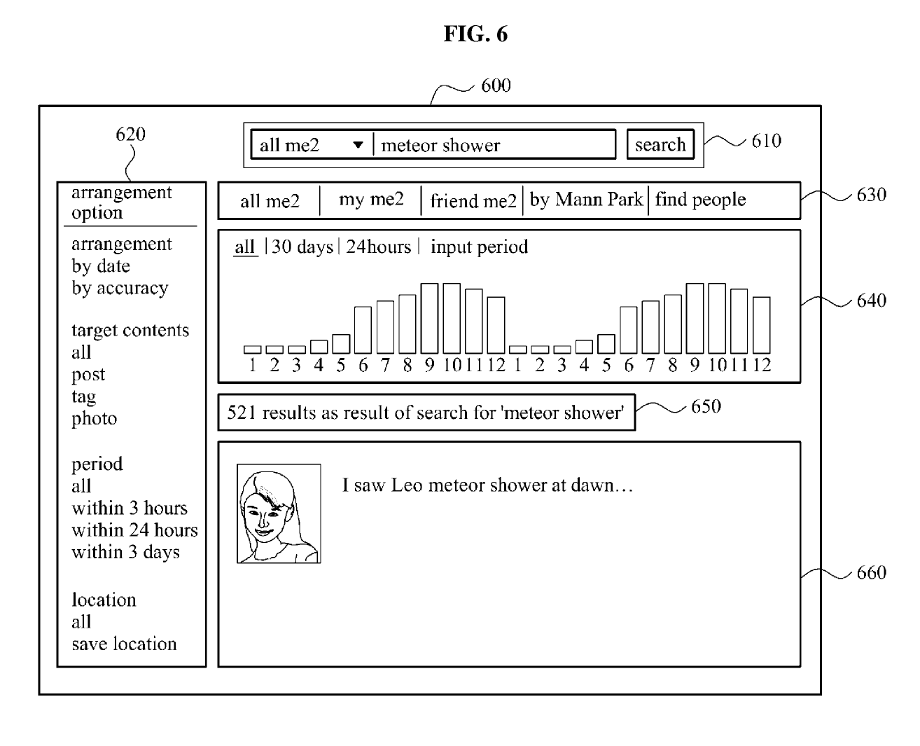

FIG. 6 illustrates a screen showing a result of a search service with respect to all posts in a search service according to an exemplary embodiment of the present invention.

Referring to FIG. 6, a search result screen 600 with respect to all posts includes a search window section 610, an arrangement option section 620, a search tab section 630, a timeline section 640, a search result number section 650, and a search result section 660. The search window section 610 is to select a search option and displays a pull-down search window option menu with a click of a mouse, and the arrangement option section 620 sets up (arrangement) latest/(target contents) all/(period) all/(location) all as a default, and may include arrangement options that may be changed by a user. The search tab section 630 activates an all me2 tab, and the timeline section 640 may display a timeline based on a search result. The search result number section 650 may display the number of search results based on a search attribute selected by the user as ‘000’ results, and the search result section 660 may display a search result based on the search attribute selected by the user. The search result section 660 displays the search result, in which a predetermined number of results are displayed on each page. In paging, a paging navigator is displayed and a page is turned while not conducting research but maintain existing search results, and when an arrangement option is changed, a page is turned to page 1.

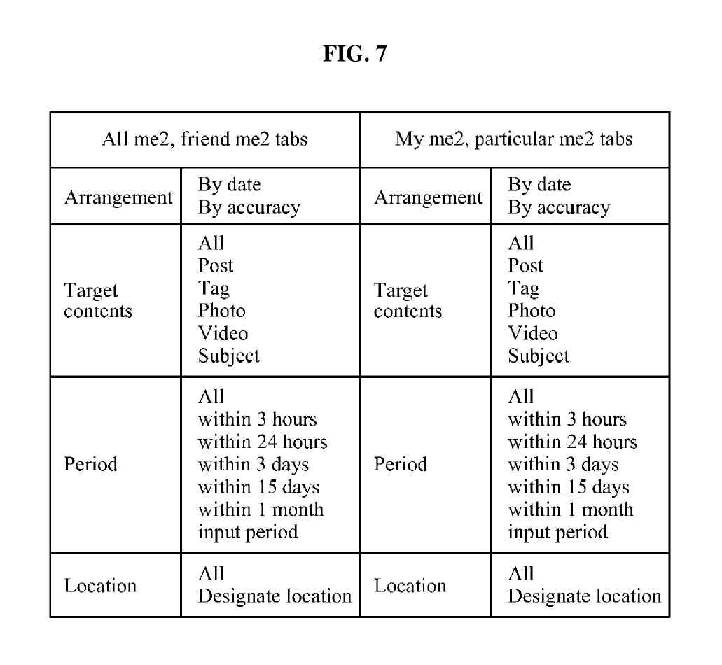

FIG. 7 illustrates an arrangement option in a search service according to an exemplary embodiment of the present invention.

Referring to FIG. 7, the arrangement option may include different default display option types and different default options for all me2, friend me2 tabs, my me2, and particular me2 tabs. The arrangement option may include an arrangement style, target contents, a period, or a location. For example, the arrangement style may include arrangement in the order of recent data or arrangement according to accuracy, and the target contents may be any one selected from all, posts, tags, photos, videos, or subjects. For example, the period may be any period selected from all, within the recent 3 hours, within the recent 24 hours, within the recent 3 days, within the recent 15 days, within the recent 1 month, and an period input, and the location may be selected from an all locations and a designated location. When the period input is clicked, time input field is displayed. Then, when an apply button is clicked, an input period is reflected on search results.

For example, when the designated location is clicked, a window to enable designation of a location on a map is displayed. When a cancel button and a close window are clicked, location designation is not set, but the ‘all’ as a default may be set. Further, the designate location may display a location change menu so that the map is closed after selection of a region, and the name of the selected region is added to the arrangement option and is re-designated. When the ‘all’ is clicked, the location may return to the default.

As to the subjects, a subject item of a search option is displayed only when there are subjects associated with a query. Also, a subject search section is displayed when the subject item is selected, and only subjects having data with respect to the query can be displayed. For example, when a cursor is located over the subject item, a tooltip displaying the number of related me2s appears, basic information is displayed in the bottom, timeline information disappears while the subject search section appears, and the subject search interactions of all pages are the same.

Further, when the subjects are selected, the subject search section is folded in a bar shape. When a subject type is selected, a corresponding type is unfolded being selected. When the bar is simply selected, a screen before being folded may be unfolded.

The timeline has the ‘all’ as a default. In the all, from the earliest to the most recent search results are displayed by the month and the entire graph is selected. The opposite ends of the graph display the date of the earliest posted search result and the data of the most recently posted search result. For example, with respect to the graph, an all, a monthly, and an enter period may be selected. A monthly graph has the most recent month positioned on the right and displays results for 24 months at once based on the month. For example, when a posting is posted over 24 months ago, the timeline provides left and right navigation, and accordingly the graph travels back and forth by one month, by clicking a left or right direction key. When the period input is selected and the “apply” is clicked, a period input window may be displayed in the timeline. For example, in the period input, when clicking a date, another date is displayed in a dropdown list.

The border of each graph may be highlighted so that the graph looks clickable when a cursor is positioned over the graph, only a selected graph is activated, and the “all period” option and a graph view mode may be deselected.

The post has the same basic configuration and operation displayed in search results as a basic posting view in Me2 day, whereas the post further includes a report and may exclude a report function from my me2, friend me2, and by particular user tabs.

When the post includes comments, a predetermined number of comments are unfolded by the user clicking the comments. When the predetermined number of comments is exceeded, a previous/next navigation is displayed, and comment interactions of all pages are the same.

The report is displayed only in a search result page all me2, and when the ‘report’ is clicked, a report layer pop-up may be displayed.

As an example, in the my me2 tab, the search result page is displayed in search after setting up the my me2 in the search window option, is displayed when clicking the my me2 tab, displays a predetermined number of search results on each page, and needs login.

As another example, in the friend me2 tab, the search result page is displayed in search after setting up the friend me2 in the search window option, is displayed when clicking the friend me2 tab, displays a predetermined number of search results on each page, and needs login.

As still another example, in the particular me2 tab, the search result page generates a particular me2 tab when selecting the “particular me2” through the search window option, generates the particular me2 tab in the case of being accessed from another user's me2, may select another particular me2 when clicking the “change,” and displays a predetermined number of search results on each page.

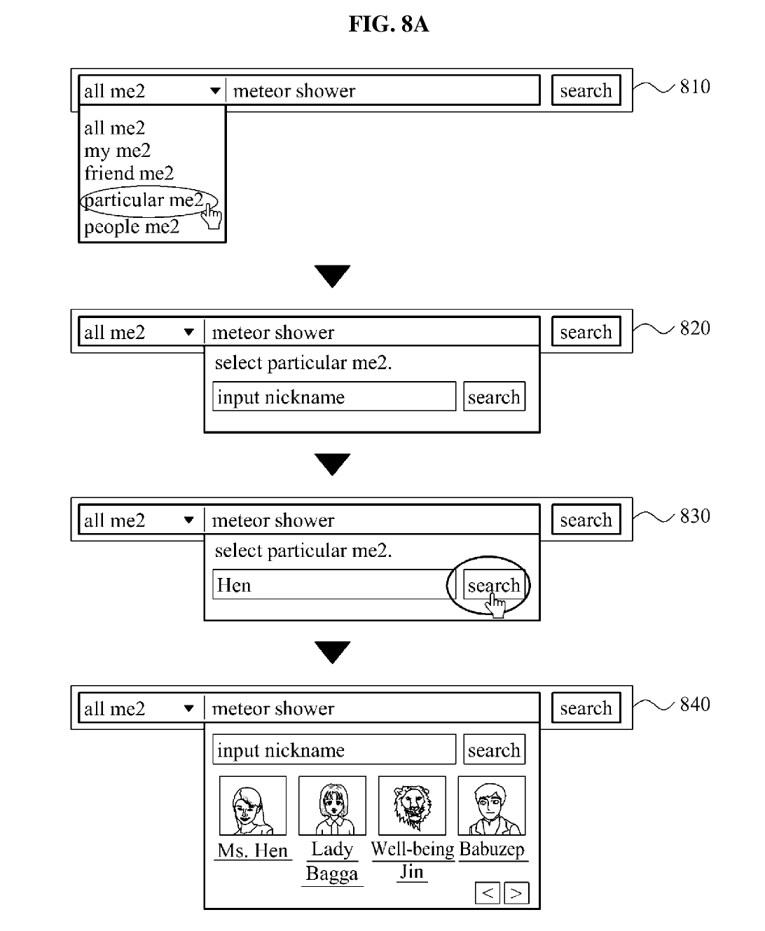

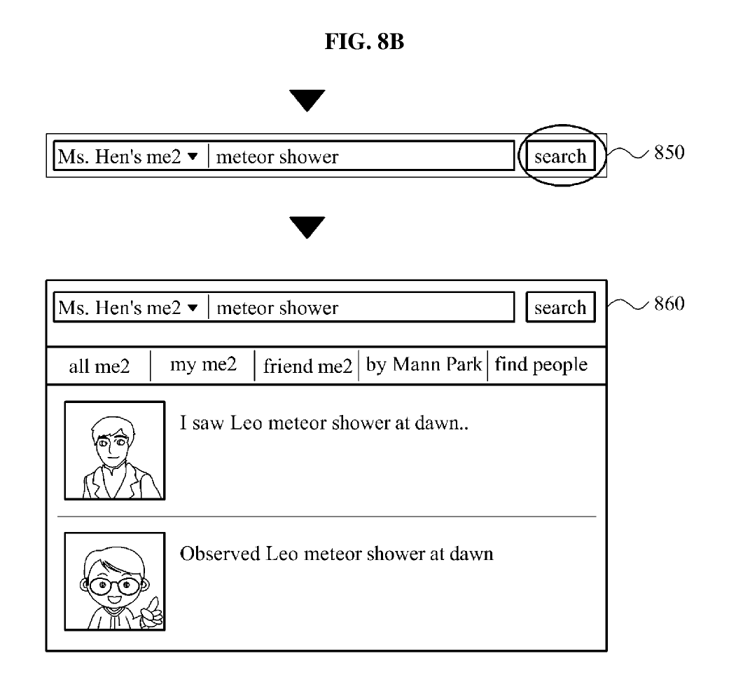

FIGS. 8A and 8B illustrate search result pages with respect to a particular subject in a search service according to an exemplary embodiment of the present invention.

Referring to FIGS. 8A and 8B, when a particular me2 is clicked in a search window option, a nickname search layer is displayed in 810, and the particular me2 is selected in the displayed nickname search layer in 820. Then, an associated nickname list is displayed when searching for nicknames in 830.

The search window option is changed to the me2 of the clicked nickname ‘Ms. Hen’ in 840, and a search result of a corresponding me2 is displayed when clicking the search button in 850.

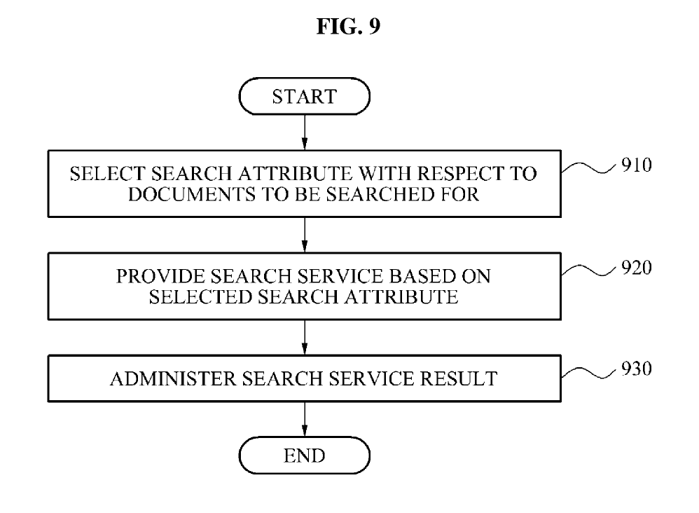

FIG. 9 illustrates an operational process of a search service method according to an exemplary embodiment of the present invention.

Referring to FIGS. 1 to 9, in operation 910, the search service system 100 selects a search attribute with respect to documents to be searched for based on a user's request. That is, in operation 910, the selection unit 210 of the search service system 100 selects the search attribute with respect to the documents to be searched for based on the user's request received from the user terminal 120 connected through the network 110.

For example, in operation 910, the selection unit 210 of the search service system 100 may select a user who has a friendship with the user or a particular user chosen by the user as the search attribute.

Alternatively, in operation 910, the selection unit 210 of the search service system 100 may select a limited category as a search attribute with respect to registered documents based on a user's request received from the user terminal 120 connected through the network 110. The limited category is a category in which the documents are registered by the user to be desirably searched for by other users or a category corresponding to a subject of the registered documents.

In another embodiment, in operation 910, the selection unit 210 of the search service system 100 may select a posting location, indicative of the location where the registered documents are registered by the user, to be set by the user or to be automatically registered, based on the user's request received from the user terminal 120 connected through the network 110.

In still another embodiment, in operation 910, the selection unit 210 of the search service system 100 may select, as the search attribute, one of a private section for administration of private postings with respect to the documents searched-for, a community section for communication with limited groups, and a common section for communication with all users based on a user's request received from the user terminal 120 connected through the network 110.

In yet another embodiment, in operation 910, the selection unit 210 of the search service system 100 may select a status of a user or a posting status with respect to a document to be searched for based on request from a user received from the user terminal 120 connected through the network 110.

In operation 920, the search service system 100 provides a search service based on the selected search attribute. That is, in operation 920, the search service provider 220 of the search service system 100 may provide a search service to the user terminal 120 connected through the network 110 based on a search attribute selected through the selection unit 210.

In one embodiment, in operation 920, the search service provider 220 of the search service system 100 may provide a search result with respect to a user selected as the search attribute to the user terminal 120 connected through the network 110.

Alternatively, in operation 920, the search service provider 220 of the search service system 100 may provide a search result with respect to the selected category among the registered documents to the user terminal 120 connected through the network 110.

In another embodiment, in operation 920, the search service provider 220 of the search service system 100 may search for a document posted within a region or scope according to the posting location and may provide the search result to the user terminal 120 connected through the network 110.

In still another embodiment, in operation 920, the search service provider 220 of the search service system 100 may provide a search result with respect to the selected search objects based on posting times of the found documents to the user terminal 120 connected through the network 110. For example, in operation 920, the search service provider 220 of the search service system 100 may provide a graphic timeline generated based on posting times of the found documents to the user terminal 120 connected through the network 110.

In yet another embodiment, in operation 920, the search service provider 220 of the search service system 100 may provide a search result of documents satisfying search target conditions with respect to the selected status of the poster or the posting status to the user terminal 120 connected through the network 110.

In operation 930, the search service system 100 provides a warning about an object to be searched for or deletes the object to be searched for when receiving a warning about the object to be searched for from a user identifying the search results or receiving a deletion request with respect to the search service from a monitor. That is, in operation 930, when receiving a warning about the object to be searched for from the user identifying the search results or receiving a deletion request with respect to the search service from the monitor, the administration unit 240 of the search service system 100 transmits a warning message to the contact address of the object to be searched for, recorded in the database 230 or deletes the object to be searched for.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### EXPLANATION OF REFERENCE NUMERALS

100: Searcy service system
210: Selection unit
220: search service provider
230: Database
240: Administration unit

1. A system of providing a search service, the system comprising:
a selection unit configured to select a search attribute with respect to documents to be searched for based on a request from a user; and
a search service provider configured to provide a search service based on the selected search attribute.

2. The system of claim 1, wherein the selection unit is configured to select a user who has a relationship with the user or a particular user designated by the user as the search attribute, and the search service provider is configured to provide a search result with respect to the user selected as the search attribute.

3. The system of claim 1, wherein the selection unit is configured to select a limited category as the search attribute with respect to registered documents, and the search service provider is configured to provide a search result with respect to the selected category from the registered documents.

4. The system of claim 3, wherein the limited category is a category in which the documents are registered by the user to be searched for by other users or a category corresponding to a subject of the registered documents.

5. The system of claim 1, wherein the selection unit is configured to select a posting location, indicative of a location where the registered documents are registered by the user, to be set by the user or to be automatically registered, and the search service provider is configured to search for a document posted within a region or scope according to the posting location and to provide a search result for the document.

6. The system of claim 1, wherein the search service provider is configured to provide a search result with respect to the selected object to be searched for based on a posting time of the found document.

7. The system of claim 6, wherein the search service provider is configured to provide a timeline graph generated based on the posting time of the found document.

8. The system of claim 1, wherein the selection unit is configured to select, as the search attribute, one of a private section for administration of private postings with respect to the documents to be searched for, a community section for communication with limited groups, and a common section for communication with all users.

9. The system of claim 1, further comprising an administration unit is configured to provide a warning with respect to the object to be searched for or to delete the object to be searched for in response to receiving a warning with respect to the object to be searched for from a user identifying a search result or receiving a deletion request with respect to the search service from a monitor.

10. The system of claim 1, wherein the selection unit is configured to select a status of a user or a posting status with respect to a document to be searched for based on the request of the user, and the search service provider is configured to provide a search result of a document satisfying search target conditions with respect to the selected status of the poster or the selected posting status.

11. A method of providing a search service, the method comprising:
selecting a search attribute with respect to documents to be searched for based on a request from a user; and
providing a search service based on the selected search attribute.

12. The method of claim 11, wherein the selecting of the search attribute comprises selecting a user who has a friendship with the user or a particular user designated by the user as the search attribute, and the providing of the search service comprises providing a search result with respect to the user selected as the search attribute.

13. The method of claim 11, wherein the selecting of the search attribute comprises selecting a limited category as the search attribute with respect to registered documents, and the providing of the search service comprises providing a search result with respect to the selected category from the registered documents.

14. The method of claim 13, wherein the limited category is a category in which the documents are registered by the user to be searched for by other users or a category corresponding to a subject of the registered documents.

15. The method of claim 11, wherein the selecting of the search attribute comprises selecting a posting location, indicative of a location where the registered documents are registered by the user, to be set by the user or to be automatically registered, and the providing of the search service comprises searching for a document posted within a region or scope according to the posting location and providing a search result for the document.

16. The method of claim 11, wherein the providing of the search service comprises providing a search result with respect to the selected object to be searched for based on a posting time of the found document.

17. The method of claim 16, wherein the providing of the search service comprises providing a graphic timeline generated based on the posting time of the found document.

18. The method of claim 11, wherein the selecting of the search attribute comprises selecting, as the search attribute, one of a private section for administration of private postings with respect to the documents to be searched for, a community section for communication with limited groups, and a common section for communication with all users.

19. The method of claim 11, further comprising managing to provide a warning with respect to the object to be searched for or to delete the object to be searched for in response to receiving a warning with respect to the object to be searched for from a user identifying the search results or receiving a deletion request with respect to the search service from a monitor.

20. The method of claim 11, wherein the selecting of the search attribute comprises selecting a status of a poster or a posting status with respect to a document to be searched for based on the request of the user, and the providing of the search service comprises providing a search result of a document satisfying search target conditions with respect to the selected status of the poster or the selected posting status.

21. A non-transitory computer-readable recording medium comprising an executable program, which when executed, causes performance of the method of claim 11.
